(19) United States
(12) Patent Application Publication
(10) Pub. No.: US 2007/0052799 A1
(43) Pub. Date: Mar. 8, 2007

(54) System and method for assisting speech development for the hearing-challenged

(75) Inventors: Simon C. Chu, Chapel Hill, NC (US); Richard A. Dayan, Wake Forest, NC (US)

Correspondence Address: IBM CORPORATION (SYL-RPS), C/O SYNNESTVEDT & LECHNER LLP, 1101 MARKET STREET, SUITE 2600, PHILADELPHIA, PA, 19107, US

(73) Assignee: International Business Machines Corporation, Armonk, NY (US)

(21) Appl. No.: 11/220,145

(22) Filed: Sep. 6, 2005

(51) Int. Cl. G09B 9/00

(52) U.S. Cl. 348/121

(57) ABSTRACT

An image projection/display system (referred to generally herein as a “display system”) is provided to assist a pupil in speech development. The display system displays an image of a face viewed from the rear, as though the pupil were viewing a mask from behind. This “mask image” is projected in front of the pupil, and the mask image is manipulated to display proper lip, mouth, and tongue movement for a particular verbalization. Since the pupil is viewing the face on the mask image from behind, there is no need for the pupil to translate the lip, mouth, and tongue movements by reversing the left and right side. A tongue movement to the right on the mask image corresponds to a tongue movement to the right by the pupil.

### BACKGROUND OF THE INVENTION

1. Field of the Invention

This invention relates to speech assistance systems and methods and, more particularly, to speech assistance systems and method directed to assisting the hearing-challenged in gaining speech proficiency.

2. Description of Related Art

Deaf or hearing challenged people find it very difficult to learn how to talk, because they have difficulty hearing, or cannot hear at all, how words are pronounced. Speech is typically taught to deaf or hearing-challenged pupils using methods whereby the pupil watches a teacher enunciate individual words and then attempts to pronounce the words by mimicking the same mouth and tongue movements. The pupil attempts to repeat the words and receives corrective and encouraging feedback from a person of normal hearing.

The above-described process is a time-consuming process. Further, the pupil must watch the mouth movements of the teacher from a “reversed” perspective, since the teacher must directly face the pupil. The pupil must translate the movements by reversing the left and right side, i.e., a movement of the teachers tongue to the teachers left is a movement to the right from the perspective of the pupil.

Accordingly, what is needed is a teaching assistant tool to allow the pupil to view the lip, tongue, and mouth movement of spoken words from the same position as the pupil is facing. In addition, a monitoring system that can evaluate each attempt at verbalizing a word by the pupil and compare it to the model word used to demonstrate the necessary mouth and tongue movements, and then provide advice to the teacher or pupil as to which corrections to make, would be beneficial also.

### SUMMARY OF THE INVENTION

In accordance with the present invention, an image projection/display system (referred to generally herein as a “display system”) is provided. The display system displays an image of a face viewed from the rear, as though the pupil were viewing a mask from behind. This “mask image” is projected in front of the pupil, and the mask image is manipulated to display proper lip, mouth, and tongue movement for a particular verbalization. Since the pupil is viewing the face on the mask image from behind, there is no need for the pupil to translate the lip, mouth, and tongue movements by reversing the left and right side. A tongue movement to the right on the mask image corresponds to a tongue movement to the right by the pupil.

In a preferred embodiment, a monitoring system monitors and records, both visually and auditorily, each attempt by the pupil to pronounce the word. A processor compares the lip, mouth, and tongue movement of the pupil to the projected face image, and provides an analysis and/or demonstrative assistance to help the pupil understand how to correct improper lip, mouth, and/or tongue movements. Further, the processor compares waveforms of voice samples of the pupil's pronunciation to a control waveform created by a person speaking correctly. This allows a further analysis of the pupil's performance and allows additional evaluation and assistance to the pupil.

### BRIEF DESCRIPTION OF THE DRAWINGS

FIGS. 1 and 2 illustrate, conceptually, the present invention;

FIG. 3 is a schematic diagram of a system enabling the present invention;

FIG. 4 is a flowchart illustrating the basic steps performed in accordance with the present invention; and

FIGS. 5A and 5B illustrate a front and side views, respectively, of a head image and is provided to illustrate an example of how the mask image can be created.

### DETAILED DESCRIPTION OF THE PREFERRED EMBODIMENTS

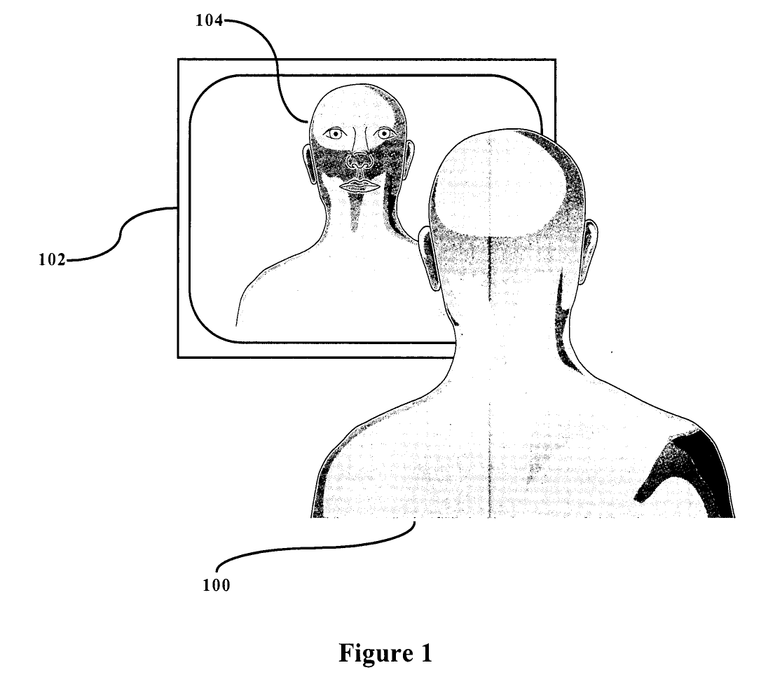

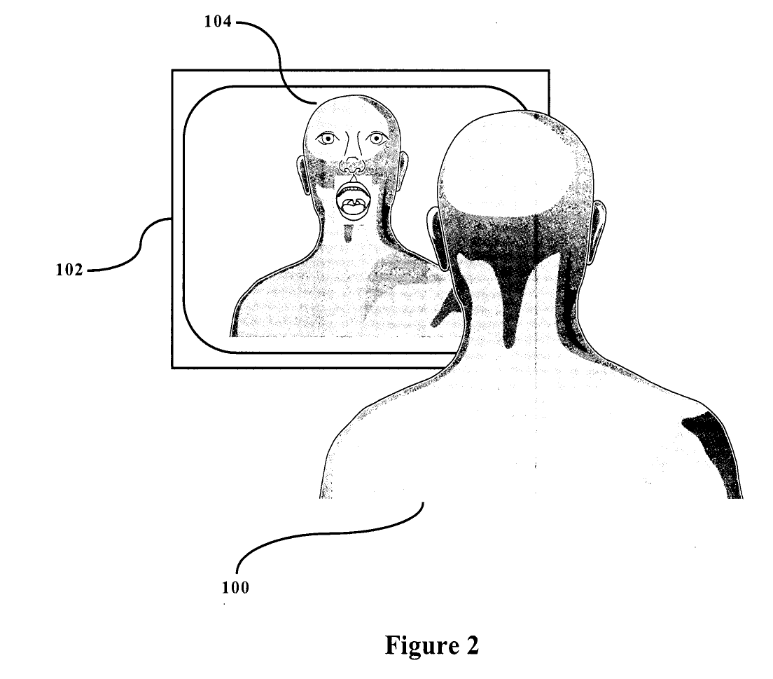

FIGS. 1 and 2 illustrate, conceptually, the present invention. Referring to FIG. 1, a pupil 100 stands in front of a display screen 102. Display screen 102 is a display device capable of displaying a “mask image” 104 resembling the rear view of a human head, a rear view as though the pupil was looking into the back of a mask, or some other similar view giving the pupil the impression that they are essentially looking through a facial image from behind. The mask image 104 can be a holographic image, but the present invention is not limited to holographic images, and any form of image that can display the mask image to the pupil can be utilized.

In FIG. 1, the mask image 104 includes a full face (eyes, nose, and mouth). It is understood, however, that the face displayed on the mask image 104 can be simplified so that all that can be seen by the pupil is a mouth. FIG. 1 shows the mouth of the mask image 104 in a closed position. Referring now to FIG. 2, FIG. 2 illustrates essentially the same view as that of FIG. 1, except that the mouth of the mask image 104 is shown opened, revealing a tongue and, if desired, other mouth features. The view of the open mouth is also from behind, so that if, for example, the mask image 104 were to stick out its tongue, the tongue would extend away from the pupil 100 in the screen image shown on display screen 102.

The system described above enables the pupil to view instructional images displayed on the display screen 102 and mimic them identically, without the need to translate the left and right movements as described above. This makes it significantly easier for the pupil to benefit from the instructional images.

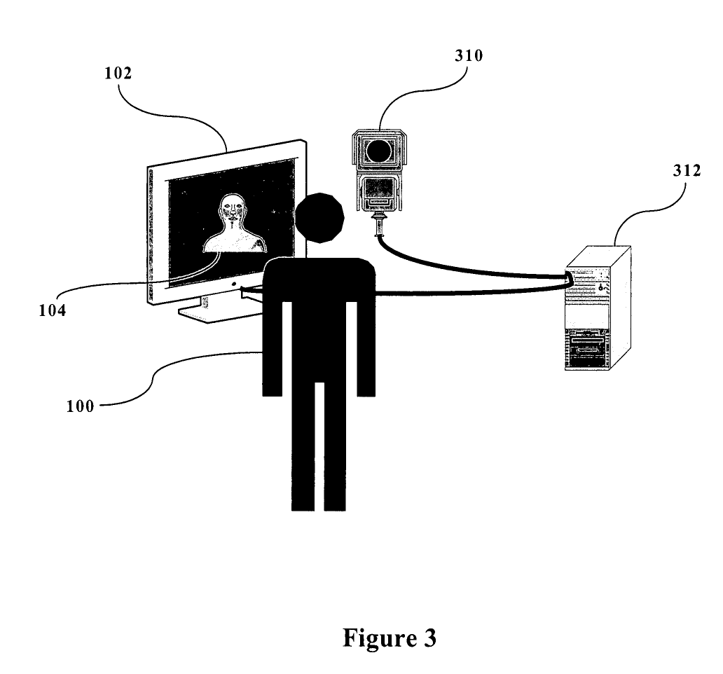

FIG. 3 is a schematic diagram of a system enabling the present invention. As shown in FIG. 3, the pupil 100 views the display screen 102, which displays to the pupil the mask image 104. Adjacent to the display screen 102 is a sound and visual recording device 310, such as a camcorder equipped with a microphone to record sounds within range of the recording device 310. Alternatively, the pupil 100 can have a microphone placed on their person or nearby, separate from the recording device 310. The recording device 310 is coupled to a processor 312, which is also coupled to display device 102.

Processor 312 can be any processing device, e.g., a PC configured with software enabling the display of mask image 104, recording of the face of the pupil 100, processing of the recorded information and performing comparison between the recorded facial movements and sounds of the pupil and the desired facial movements and sounds, as represented by the mask image 104.

In use, pupil 100 stands in front of display 102 and views the mask image 104 being displayed thereon. At the appropriate times, pupil 100 attempts to mimic the mouth, lip and tongue movements of the mask image 104. Recording device 310 records the images and sounds of the pupil 100 when pupil 100 mimics the mask image 104.

Processor 312 receives data representing the recorded sound and/or images from recording device 310 and, using known sound and/or imaging processing techniques, the processor performs a comparison between the recorded images/sounds of the pupil and data representing the actions that the pupil was instructed to mimic, and provides instructions to pupil 100 via display screen 102. Such instructions can be written on the screen; more preferably, the processor 312 causes mask image 104 to provide instructional images, i.e., focused mouth, lip, and/or tongue movements to show the pupil the correct way to pronounce the particular word, sound, phrase, etc.

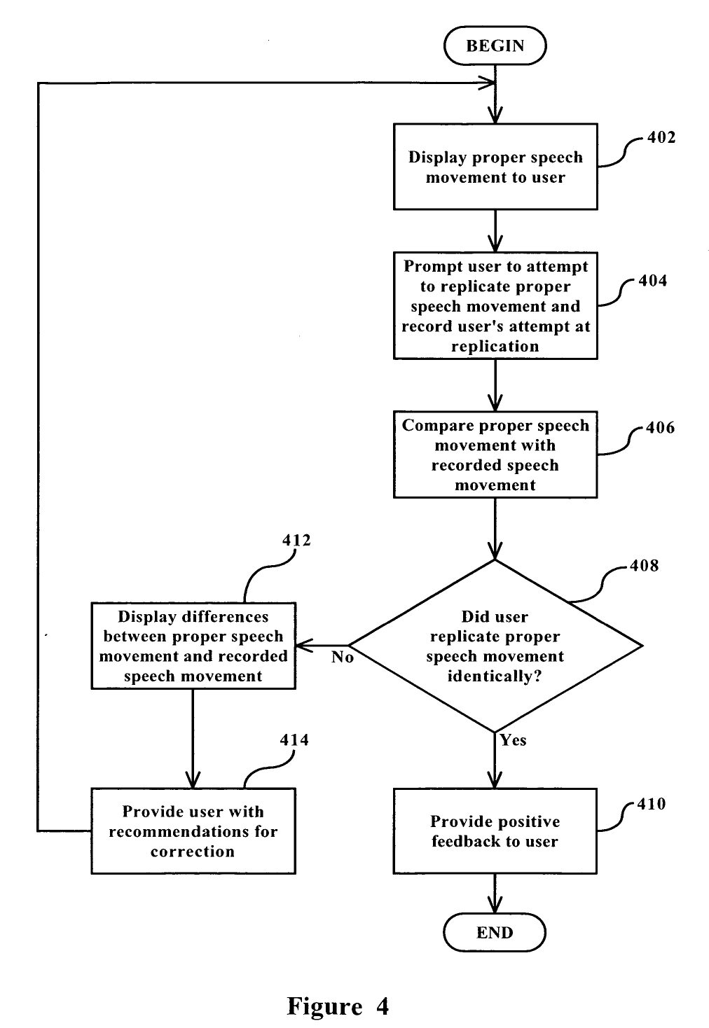

FIG. 4 is a flowchart illustrating the basic steps performed in accordance with the present invention. At step 402, the proper speech movements are displayed to the user. As described above, this can be displayed to the user on a display screen, and is done so using a mask image enabling the user to see the movements as though the user was looking through the back of a mask.

At step 404, the user is prompted to attempt to replicate proper speech movement. This attempt is recorded by the sound and visual recording device.

At step 406, the proper speech movement is compared with the recorded speech movement as discussed above. At step 408, a determination is made as to whether or not the user properly replicated the proper speech movement. If the user identically replicated the proper speech movement, the process proceeds to step 410, where the user is provided with positive feedback indicating identical replication.

If, however, at step 408, it is determined that the user did not replicate the proper speech movement essentially identically, the process proceeds to step 412, where the differences between the proper speech movement and the recorded speech movement are displayed to the user. At step 414, the user may be provided with recommendations for correction, which may also be displayed on the display device. The process then proceeds back to step 402 for the user to again attempt to replicate the proper speech movement, based upon viewing a display of the proper speech movement.

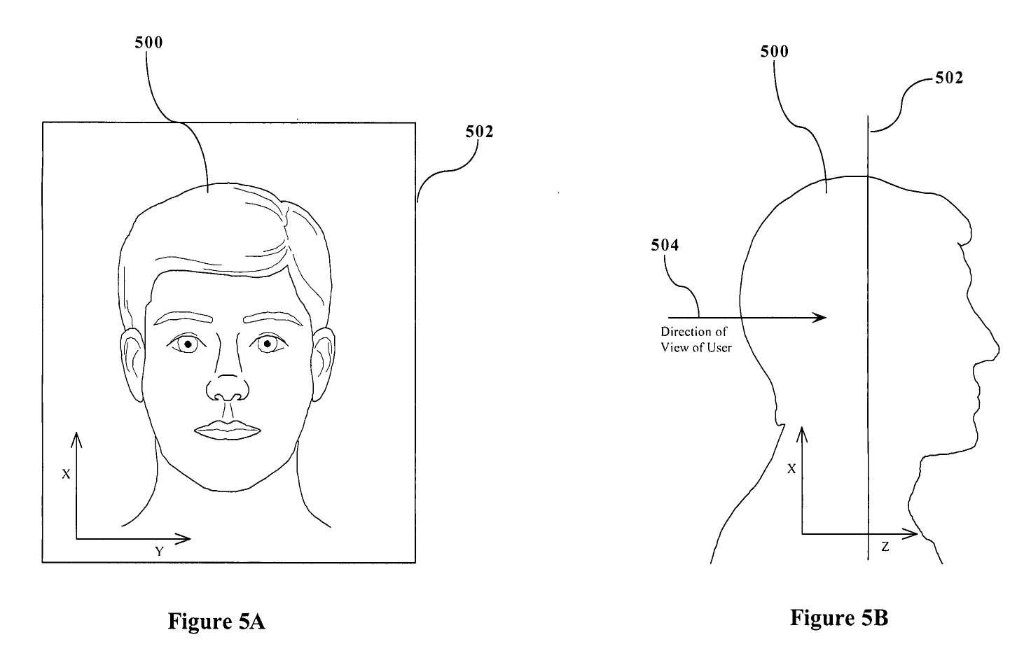

FIGS. 5A and 5B illustrate a front and side views, respectively, of a head image and is provided to illustrate an example of how the mask image can be created. The mask image can be created in multiple ways. A hologram of a head 500 can be created in a well known manner. The head 500 can be a picture of the person being trained, of another person, an averaged composite of several heads, or it can be a drawing of a head of a non-existent person as shown in FIGS. 5A and 5B. The hologram is then digitized using well-known methods. This digitizing process includes measurements in all three axes (x, y, and z).

The head 500 is then vertically “sliced” along a plane 502 parallel to the plane containing the vertical (x) axis and both ears, e.g., just behind the eyes or ears. The inside of the remaining face is then sanitized or “hollowed out” to remove images of all tissue with the exception of the tongue and mouth and the outline of the head itself.

The remaining portion or mask is then rotated around using well known mathematical algorithms, so that a user of the present invention can look into the mask in the direction indicated by arrow 504 of FIG. 5B.

It is important to remember that if the mask is symmetrical in appearance, the perception of the image by a person staring at the mask for extended periods may be inverted so that it may look as though they are looking at the front of a face. Using asymmetric facial features will help defeat such reversal of the mask's orientation. For example, shading, bumps on one side of the face, coloring and other 3-D modeling and rendering techniques may be used to reduce the tendency to fixate on the mask and thus minimize the tendency for the image to appear inverted as described above.

The above-described steps can be implemented using standard well-known programming techniques. The novelty of the above-described embodiment lies not in the specific programming techniques but in the use of the steps described to achieve the described results. Software programming code which embodies the present invention is typically stored in permanent storage. In a client/server environment, such software programming code may be stored with storage associated with a server. The software programming code may be embodied on any of a variety of known media for use with a data processing system, such as a diskette, or hard drive, or CD ROM. The code may be distributed on such media, or may be distributed to users from the memory or storage of one computer system over a network of some type to other computer systems for use by users of such other systems. The techniques and methods for embodying software program code on physical media and/or distributing software code via networks are well known and will not be further discussed herein.

It will be understood that each element of the illustrations, and combinations of elements in the illustrations, can be implemented by general and/or special purpose hardware-based systems that perform the specified functions or steps, or by combinations of general and/or special-purpose hardware and computer instructions.

These program instructions may be provided to a processor to produce a machine, such that the instructions that execute on the processor create means for implementing the functions specified in the illustrations. The computer program instructions may be executed by a processor to cause a series of operational steps to be performed by the processor to produce a computer-implemented process such that the instructions that execute on the processor provide steps for implementing the functions specified in the illustrations. Accordingly, the figures support combinations of means for performing the specified functions, combinations of steps for performing the specified functions, and program instruction means for performing the specified functions.

While there has been described herein the principles of the invention, it is to be understood by those skilled in the art that this description is made only by way of example and not as a limitation to the scope of the invention. Accordingly, it is intended by the appended claims, to cover all modifications of the invention which fall within the true spirit and scope of the invention.

We claim:

1. A computer-implemented method for teaching proper mouth movements, comprising:
displaying, on a video display, a mask image of a face to a user, oriented such that a user of the method views the mask image from the perspective of the back of the mask; and
manipulating, using a processor, a mouth of the mask image to present the user with proper mouth movements needed to articulate a particular sound.

2. The method of claim 1, further comprising:
recording an attempt by the user to replicate the proper mouth movements needed to articulate the particular sound;
comparing the recorded attempt by the user with the proper mouth movement; and
outputting a result of the comparison.

3. The method of claim 2, wherein said result of the comparison is output to a video display device viewable by the user, and wherein said output result includes a display of corrective measures that can be taken by the user to correct any discrepancies between the proper mouth movement and the user's recorded attempt to replicate the proper mouth movement.

4. The method of claim 3, wherein said recording of an attempt by the user to replicate the proper mouth movements needed to articulate the particular sound includes both video and audio recording of the attempt at replication.

5. The method of claim 4, wherein the outputting of a result of the comparison includes visual representations showing the differences between the proper mouth movement and the user's recorded attempt to replicate the proper mouth movement.

6. A computer-implemented system for teaching proper mouth movements, comprising:
display means for displaying a mask image of a face to a user, oriented such that a user of the system views the mask image from the perspective of the back of the mask; and
processing means configured to manipulate a mouth of the mask image to present the user with proper mouth movements needed to articulate a particular sound.

7. The system of claim 6, further comprising:
means for recording an attempt by the user to replicate the proper mouth movements needed to articulate the particular sound;
means for comparing the recorded attempt by the user with the proper mouth movement; and
means for outputting a result of the comparison.

8. The system of claim 7, wherein said result of the comparison is output to a video display device viewable by the user, and wherein said output result includes a display of corrective measures that can be taken by the user to correct any discrepancies between the proper mouth movement and the user's recorded attempt to replicate the proper mouth movement.

9. The system of claim 8, wherein said recording of an attempt by the user to replicate the proper mouth movements needed to articulate the particular sound includes both video and audio recording of the attempt at replication.

10. The system of claim 9, wherein the outputting of a result of the comparison includes visual representations showing the differences between the proper mouth movement and the user's recorded attempt to replicate the proper mouth movement.

11. A computer program product for teaching proper mouth movements, the computer program product comprising a computer-readable storage medium having computer-readable program code embodied in the medium, the computer-readable program code comprising:
computer-readable program code that displays, on a video display, a mask image of a face to a user, oriented such that a user of the method views the mask image from the perspective of the back of the mask; and
computer-readable program code that manipulates, using a processor, the mouth of the mask image to present the user with proper mouth movements needed to articulate a particular sound.

12. The computer program product of claim 11, further comprising:
computer-readable program code that stores a recording of an attempt by the user to replicate the proper mouth movements needed to articulate the particular sound;
computer-readable program code that compares the recorded attempt by the user with the proper mouth movement; and
computer-readable program code that outputs a result of the comparison.

13. The computer program product of claim 12, wherein said result of the comparison is output to a video display device viewable by the user, and wherein said output result includes a display of corrective measures that can be taken by the user to correct any discrepancies between the proper mouth movement and the user's recorded attempt to replicate the proper mouth movement.

14. The computer program product of claim 13, wherein said recording of an attempt by the user to replicate the proper mouth movements needed to articulate the particular sound includes both video and audio recording of the attempt at replication.

15. The computer program product of claim 14, wherein the outputting of a result of the comparison includes visual representations showing the differences between the proper mouth movement and the user's recorded attempt to replicate the proper mouth movement.
